(19) United States
(12) Patent Application Publication
(10) Pub. No.: US 2023/0004428 A1
(43) Pub. Date: Jan. 5, 2023

(54) DATA PREPROCESSING FOR A SUPERVISED MACHINE LEARNING PROCESS

(71) Applicant: LUXEMBOURG INSTITUTE OF SCIENCE AND TECHNOLOGY (LIST), Esch-sur-Alzette (LU)

(72) Inventor: Nicolas Biri, Joudreville (FR)

(21) Appl. No.: 17/777,323

(22) PCT Filed: Nov. 18, 2020
(86) PCT No.: PCT/EP2020/082557

§ 371 Date: May 17, 2022

(30) Foreign Application Priority Data
Nov. 18, 2019 (LU) LU101480

(51) Int. Cl. G06F 9/48; G06F 8/41

(52) U.S. Cl. CPC G06F 9/4881; G06F 8/433; G06F 2209/486

(57) ABSTRACT

A computer-implemented data processing method, including the steps of: providing a first program including a group of operations arranged to satisfy a first set of operation dependencies, the group of operations being adapted for computing data from at least one data source, generating a second program including the group of operations, arranged to satisfy a second set of operation dependencies, and processing the data from the at least one data source with the second program. The group of operations includes a first operation, a second operation, and a third operation. The first set of operation dependencies includes a first dependency between the first operation and the second operation, a second dependency between the first operation and the third operation, and a third dependency between the second operation and the third operation.

### TECHNICAL FIELD

The invention lies in the field of data processing. More precisely, the invention offers a method for optimizing the definition of operation dependencies of a provided raw computer program. The invention also provides a computer program for carrying out the method in accordance with the invention. The invention also provides a computer configured for performing the method in accordance with the invention.

### BACKGROUND OF THE INVENTION

The supervised learning phase of a machine learning process generally requires to preprocess the learning data. Indeed, the learning data potentially comprises incomplete data and noise instances which must be removed. Otherwise, the machine learning algorithm may present an important error after generalization, or the learning phase may never converge toward a satisfying solution.

In some technical domains, the learning dataset may comprise millions of data records. Thus, saving these records, at the different stages of pre-processing, necessitates a heavy storage infrastructure. In addition, a long runtime remains inescapable for preprocessing the learning dataset in order to clean it. As a corollary, energy consumption remains high.

Last but not least, the learning data may be stored on different data sources. The data storages may use different architectures, and may use different languages. These multiple sources further complicate data preparation.

The document US2018/336020 A1, the document US2017/147943 A1 and the document US2018/276040 A1 provide data processing computer programs.

### Technical Problem to be Solved

It is an objective of the invention to present a method, which overcomes at least some of the disadvantages of the prior art. In particular, it is an objective of the invention to optimize a computer implemented data processing method.

### SUMMARY OF THE INVENTION

According to a first aspect of the invention it is provided a computer implemented data processing method, comprising the steps of: providing a first program comprising a group of operations arranged to satisfy a first set of operation dependencies, said group of operations being adapted for computing data from at least one data source; generating a second program comprising said group of operations, arranged to satisfy a second set of operation dependencies; processing the data from the at least one data source with the second program; wherein: the group of operations comprises: a first operation, a second operation, and a third operation; the first set of operation dependencies comprises: a first dependency between the first operation and the second operation, a second dependency between the first operation and the third operation, and a third dependency between the second operation and the third operation; at step generating, the second set of operation dependencies is defined with the first dependency, the third dependency; and without the second dependency.

Preferably, the process comprises the step parsing the first program in order to identify the operation dependencies, or a step obtaining the operation dependencies.

Preferably, the process comprises the step analysing the connections between the operation dependencies, or a step analysing, or a step analysing operation data, or a step analysing operation precedence, or a step analysing operation dependencies.

Preferably, the process comprises the step changing the arrangement of the operations of the group of operations in order to satisfy a second set of operation dependencies which is defined with the first dependency, the third dependency; and optionally without the second dependency. Preferably, the operation dependencies of the first set and of the second set may be precedence dependencies, notably imposing to perform the first operation before the second operation. Preferably, the first set may comprise more operation dependencies than the second set. Preferably, the group of operations may further comprise a fourth operation, the first set further may comprise a fourth dependency between the first operation and the fourth operation, the second operation being dependency free with respect to the fourth operation.

Preferably, at step generating, the dependency between the second operation and the fourth operation may be such that they may be executed in parallel, and/or at step generating the second set of operation dependencies may be defined with the fourth dependency, the fourth dependency may be configured such that at step processing the fourth operation may be executed before the third operation and possibly before the second operation.

Preferably, all the operations dependent upon at least one operation dependency of the second set may also be dependent upon at least one operation dependency of the first set.

Preferably, at least one operation of the group of operations may be a data transformation operation.

Preferably, at least one operation of the group of operations may be a loading instruction. Preferably, at least one operation of the group of operations may be a data creation function, which reuse pieces of data of the at least one data source, and may comprise an order priority which is modified, notably lowered, in the second program, as compared to the first program.

Preferably, at least one operation of the group of operations may be a filtering operation, and comprises an execution order which may be brought forward in the second program, as compared to the first program.

Preferably, said data comprises a first data set, the at least one data source is a first data source and may further comprise a second data source which may provide a second data set, at least one of the operations may be a joining operation merging the first data set and the second data set. Preferably, at least one operation of the first operation, second operation and third operation may enable a size reduction of the data from at least one data source, said at least one operation being permuted in the second program with respect to the first program. Said at least one operation may be a filtering operation. The data may be an input data, or an output data.

Preferably, at step providing the first program, the operation dependencies may be obtained by parsing the operations of the first program and/or by analysing part of the data involved in these operations.

Preferably, at step providing, at least one of the operation dependencies may be predefined, or provided.

Preferably, the operations in the first program and in the second program may comprise a same end operation and/or a same starting operation.

Preferably, the first program and the second program may be configured for providing a same output when they are provided with a same input.

Preferably, in the first program, the operations of the group of operations may be listed in accordance with a first sequence, and in the second program the execution order between the second operation and the third operation may be inverted with respect to the first sequence. Preferably, the computer implemented data processing method may comprise a step computing a first directed acyclic graph corresponding to the first program.

Preferably, the computer implemented data processing method may comprise a step displaying, using a displaying unit, a second directed acyclic graph corresponding to the second program; without the second dependency; each graph comprising nodes corresponding to the operations of the group of operations, and may further comprise edges joining the nodes.

Preferably, at step obtaining, the first program may be provided in a first programming/coding language, and at step generating the second program may be provided a second programming/coding language, which may be different from the first language.

Preferably, the first program may run on a first computer, and/or the second program may run on a data server.

Preferably, the data server may be a distributed data server on different computers which may be interconnected, the different computers may be separate and distinct physical entities.

Preferably, the method may comprise a step associating priority levels to the operation dependencies and/or to the operations, at step generating the order between the operations may be defined in relation with said priority levels.

Preferably, the computer implemented data processing method may be an iterative method, a program resulting from the step generating said second program may be stored in a memory element after a first iteration, the subsequent program resulting from a subsequent iteration may be stored in a memory element and compared to the program resulting from the first iteration. Preferably, the computer implemented data processing method may comprise a step sending instructions to a database storing the data, the instruction may be an instruction to run the second program and may be coded in a language of the at least one data source.

Preferably, the computer implemented data processing method may be a supervised machine learning data pre-processing method, and the data may be a learning data for the supervised machine learning data pre-processing method.

Preferably, the computer implemented data processing method may further comprise a step combining at least one operation dependency of the first set with at least one operation dependency of the first set in order to form a combined dependency, if another operation dependency of the first set corresponds to the combined dependency, then at step generating, the second set of operation dependencies may be defined without said another operation dependency.

Preferably, the first dependency may be an elementary dependency and the second dependency may be a bypass dependency bypassing the second operation with which the elementary dependency is associated, at step generating the operation dependencies of the second set may be defined without the bypass dependency/dependencies.

Preferably, if two operations mentioned in the first set are also mentioned in the second set, then at step generating the order between the operations of the first set may be defined without one redundant operation dependency.

Preferably, step generating may be executed with computing means.

Preferably, the operation dependencies may comprise elementary dependencies, such as the first dependency and the third dependency; and bypass dependency, such as the second dependency, which may be composed of elementary dependencies; at step generating the orders between the operations may be defined without the bypass dependency.

Preferably, the bypass dependency may be a composed dependency, at step generating the order between the operations may be defined without the composed dependency.

Preferably, each operation dependency may be defined with respect to an antecedent operation or a successor operation.

Preferably, at step processing the second operation and the fourth operation may be run in parallel. Preferably, the operations may be predecessor operations.

Preferably, at step generating, the order between the operations may be defined by the first dependency and the third dependency.

Preferably, at step generating, the second dependency may be disabled.

Preferably, at step obtaining, the second dependency may bypass the second operation.

Preferably, before step generating the first set and/or the second set may be simplified by reducing their numbers of operation dependencies.

Preferably, the operation dependencies of the first set and of the second set may be order dependencies, notably order constraints.

Preferably, at least one operation of the group of operations may be a filtering operation. Preferably, the method may comprise a step merging the first data set and the second data set. Preferably, before step generating, each operation dependency of the second set may be applied to the operations dependent upon operation dependencies of the first set such that the second dependency forms an overlapping dependency which overlaps the third dependency, at step generating the operation dependencies between the operations of the second set may be defined without the overlapping dependency/dependencies.

Preferably, before step generating, each operation dependency of the second set may be integrated in the first set rendering redundant the second dependency, at step generating the operation dependencies between the operations of the second set may be defined without the redundant dependency/dependencies.

Preferably, the operations may comprise at least one heuristic.

It is another object of the invention to provide a computer implemented data processing method, comprising the steps of:

providing a first program comprising a group of operations arranged to satisfy a first set of operation dependencies, said group of operations being adapted for computing data from at least one data source;

generating a second program comprising said group of operations, arranged to satisfy a second set of operation dependencies;

processing the data from the at least one data source with the second program;

wherein:

the group of operations comprises:

a first operation,

a second operation, and

a third operation;

the first set of operation dependencies comprises:

a first dependency between the first operation and the second operation,

a second dependency between the first operation and the third operation, and

a third dependency between the second operation and the third operation;

the computer implemented data processing method further comprises a step combining at least one operation dependency of the first set with at least one operation dependency of the first set in order to form a combined dependency, if another operation dependency of the first set corresponds to the combined dependency, then at step generating the second set of operation dependencies is defined with the first dependency, the third dependency; and without said another operation dependency.

It is another aspect of the invention to provide a computer implemented data processing method comprising the steps of: providing a first program comprising a group of operations arranged to satisfy a first set of operation dependencies, said group of operations being adapted for computing data from at least one data source in order to provide a first data result; the group of operations comprises: a first operation, a second operation, and a third operation; the first set of operation dependencies comprises: a first dependency between the first operation and the second operation, a second dependency between the first operation and the third operation, and a third dependency between the second operation and the third operation; the method further comprising the steps: generating a second program comprising said group of operations, arranged to satisfy a second set of operation dependencies, said second set being defined with the first dependency, the third dependency; and optionally without the second dependency; processing the data from the at least one data source with the second program in order to provide a second data result, said second data result corresponding to the first data result. The feature without the second dependency is not an essential aspect of the invention.

It is another aspect of the invention to provide a computer implemented data processing method comprising the steps of: providing a first program comprising a group of operations arranged to satisfy a first set of operation dependencies, said group of operations being adapted for computing data from at least one data source in order to provide a first data result;

the group of operations comprises: a first operation, a second operation, and a third operation;
the first set of operation dependencies comprises: a first dependency between the first operation and the second operation, a second dependency between the first operation and the third operation, and a third dependency between the second operation and the third operation;
   the method further comprising the steps:
   parsing the first program in order to identify the operation dependencies;
   analysing the connections between the operation dependencies;
   changing the arrangement of the operations of the group of operations in order to satisfy a second set of operation dependencies which is defined:
   with the first dependency, the third dependency; and without the second dependency;
   generating a second program comprising said group of operations, arranged to satisfy the second set of operation dependencies;
      processing the data from the at least one data source with the second program in order to provide a second data result, said second data result corresponding to the first data result; and/or said second data being equivalent to the first data result. Step analysing is not an essential aspect of the invention.

It is another aspect of the invention to provide a computer implemented method for arranging operations of a first program for processing data from at least one data source, the first program comprises order dependent operations with, namely, a first operation, a second operation and a third operation, the first program comprising a first operation arrangement with order constraints, said order constraints comprising: a first order constraint between the first order dependent operation and the second order dependent operation, a second order constraint between the first order dependent operation and the third order dependent operation, and a third order constraint between the second order dependent operation and the third order dependent operation; the method comprising the steps: identifying the order dependent operations among the operations of the first program; obtaining the order constraint among the order dependent operations; generating a second program with a second operation arrangement where the order between the operations is defined without the second order constraint, and processing the data with the second program.

It is another aspect of the invention to provide a computer implemented method for constraining operations of a first program for processing data from at least one data source, notably a data flow, the method notably being a supervised machine learning data pre-processing method, the first program comprising a plurality of operations; the method comprising the steps: identifying order dependent operations among the operations; obtaining order constraints among the order dependent operations, at least one order dependent operation constraint having at least two order constraints, at least one order dependent operation comprising two order constraints with respect to two other order dependent operations which are order dependent, simplifying dependencies by integration of order constraints in each other, integrating order constraints in each other, remove redundant order constraint(s) in the order dependent operation comprising two order constraints, then provide a second operation arrangement, such as a program update, where the arrangement of the operations and/or the order of the operations is defined by the remaining order constraints; generating a code implementing the second operation arrangement, said code being executable by a processor and/or a database; and run the code with at least one computer processor.

It is another aspect of the invention to provide a computer program comprising computer readable code means, which when run on a computer, cause the computer to perform the computer implemented data processing method according to the invention.

It is another aspect of the invention to provide a computer program product including a computer readable medium on which the computer program according to the invention is stored.

It is another aspect of the invention to provide a computer configured for performing the computer implemented data processing method according to the invention.

The different aspects of the invention may be combined to each other. In addition, the preferable features of each aspect of the invention may be combined with the other aspects of the invention, unless the contrary is explicitly mentioned.

### Technical Advantages of the Invention

The invention reduces constraints between operations, and offers a lightweight solution for defining dependencies. Over an automatic definition of dependencies, only relevant ones are kept and redundant ones are disabled. Thus, data storage required for storing the dependencies is reduced.

The invention drives toward a parallelized operation sequence. Starting from a single path sequence, parallel branches are automatically added where applicable. Thence, the preprocessing in line with the invention saves time.

The orders of different operations are automatically redefined where applicable. Due to the invention, dependencies between operations may allow a simultaneous execution, and reverse the execution order between specific operations.

Useless computations are prevented, and the remaining are split, divided, distributed, to shorten the computation period.

### BRIEF DESCRIPTION OF THE DRAWINGS

Several embodiments of the present invention are illustrated by way of figures, which do not limit the scope of the invention, wherein

FIG. 1 provides a schematic illustration of a first directed acyclic graph in accordance with a preferred embodiment of the invention;

FIG. 2 provides a schematic illustration of a diagram bock of a computer implemented data processing method in accordance with a preferred embodiment of the invention;

FIG. 3 provides a schematic illustration of another first directed acyclic graph in accordance with a preferred embodiment of the invention;

FIG. 4 provides a schematic illustration of another diagram bock of a computer implemented data processing method in accordance with a preferred embodiment of the invention;

FIG. 5 provides another schematic illustration of a first directed acyclic graph in accordance with a preferred embodiment of the invention;

FIG. 6a provides a schematic illustration of a second directed acyclic graph in accordance with a preferred embodiment of the invention;

FIG. 6b provides another schematic illustration of the second directed acyclic graph in accordance with a preferred embodiment of the invention;

FIG. 6c provides another schematic illustration of the second directed acyclic graph in accordance with a preferred embodiment of the invention;

FIG. 7a provides another schematic illustration of the second directed acyclic graph in accordance with a preferred embodiment of the invention;

FIG. 7b provides another schematic illustration of the second directed acyclic graph in accordance with a preferred embodiment of the invention;

FIG. 8 provides another schematic illustration of the second directed acyclic graph in accordance with a preferred embodiment of the invention;

FIG. 9 provides another schematic illustration of the second directed acyclic graph in accordance with a preferred embodiment of the invention.

### DETAILED DESCRIPTION OF THE INVENTION

This section describes the invention in further detail based on preferred embodiments and on the figures. Similar reference numbers will be used to describe similar or the same concepts throughout different embodiments of the invention.

It should be noted that features described for a specific embodiment described herein may be combined with the features of other embodiments unless the contrary is explicitly mentioned. Features commonly known in the art will not be explicitly mentioned for the sake of focusing on the features that are specific to the invention. For example, the computer in accordance with the invention is well known by the skilled in the art. Therefore, such a computer will not be described further. Similarly, databases and computer networks that may be used in the environment of the invention are well known concepts that do not need to be detailed further.

By convention, it is understood that supervised leaning designates machine learning tasks requiring labelled training data to infer a statistical model. The learning phase designates the phase during which labelled data is provided to an algorithm to infer the statistical model.

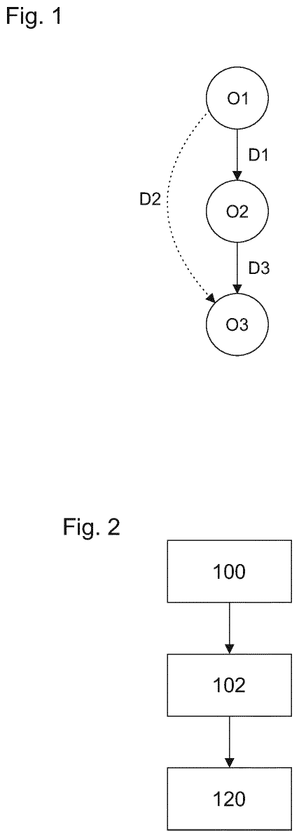

FIG. 1 shows a computer program, notably a first program comprising. A corresponding directed graph is provided. The computer program may be a preprocessing method for data of a machine learning algorithm. More precisely, the algorithm may be a supervised machine learning algorithm. The data may be a learning data and/or a validation data. The considered data may be a subset of data available on storing means.

The first program comprises a group of operations arranged to satisfy a first set of operation dependencies. This group of operations is adapted for computing data from at least one data source. The group of operations comprises at least: a first operation O1, a second operation O2, and a third operation O3.

The first set of operation dependencies comprises: a first dependency D1 (represented in solid line) between the first operation O1 and the second operation O2, a second dependency D2 (represented in solid line) between the first operation O1 and the third operation O3, and a third dependency D3 (represented in doted lines) constraining the second operation O2 with respect to the third operation O3. Thus, the first operation is dependent upon the second operation and the third operation, which are also order dependent with respect to each other.

The dependencies (D1; D2; D3) may be unidirectional. The dependencies (D1; D2; D3) may be precedence dependencies. The dependencies (D1; D2; D3) are hereby represented by arrows. They may comprise order rules. These rules may define that the first operation O1 is carried out before second operation O2, which is itself executed before the third operation O3.

It may be noticed that the second dependency D2 is defined in relation with the first operation O1 and the third operation O3; whereas these operations are also used to define the first dependency D1 and the third dependency D3. The second operation O2 forms an intermediate operation that is used to define the first and third dependencies (D1; D3). In the current illustration, the second operation O2 is bypassed, or worked around, by the second dependency D2. The former may de considered as a short cut jumping an operation; namely the second operation O2.

It may be understood that the result of the second dependency D2 is composed of the first dependency D1 and the third dependency D3. The second dependency D2 may involve a redundant definition of the combination of the first dependency D1 and the third dependency D3. It may be deduced from the current representation that the first dependency D1 and the third dependency D3 cover the second dependency D2. Therefore, the latter may overlap the formers.

FIG. 2 shows a diagram block representing a computer implemented data processing method in accordance with the invention. The computer implemented data processing method may be executed on a computer program, notably a first computer program, as described in relation with FIG. 1.

The computer implemented data processing method comprises the steps of:

providing 100 a first program comprising a group of operations arranged to satisfy the first set of operation dependencies, said group of operations being adapted for computing data from at least one data source;
generating 102 a second program comprising said group of operations, arranged to satisfy a second set of operation dependencies; and
processing 120 the data from the at least one data source with the second program.

At step generating 102, the second set of operation dependencies is defined with the first dependency, the third dependency; but without the second dependency. It may be considered that the second dependency is discarded; or disabled. It may be understood that the second dependency is removed, or deleted. Thus, the second set is free of the so called second dependency.

Step generating 102 is executed with computing means, or more generally with electronic means. The simplified first program provides an illustrative example. The first program may comprise further operations, and additional dependencies between the operations.

As apparent from the above method, the invention reduces the number of dependencies that are considered for generating the second computer program. Thus, this program generation which may be automatized is less constrained, and the second program is easier to obtain. Thus, the computation resources required for providing the second program are reduced. Moreover, the second set of dependencies is smaller than the first one, such that less memory the required. Fewer reading instructions are necessary. The invention thereby saves energy.

The current computer implemented data processing method way be coded in another computer program, for instance with computer readable code means. When said computer readable code means is executed on a computer, said computer carries out the processing method in accordance with the invention. Said another computer program may be stored on a computer program product including a computer readable medium, such as a storing key, or on a card, or any other storing support.

As an option, before step generating, the data processing process comprises a step parsing the first computer program in order to identify the operation dependencies of the first set.

As an option, before step generating, the data processing process comprises a step analysing the connections between the operation dependencies.

As an option, before step generating, the data processing process comprises a step changing the operation arrangement in order to meet a second set of operation dependencies. The second set differs from the first set in that it is freed from the second dependency.

The data processing process may comprise a step copying or loading the group of operations of the first program. The operations of the first group may be used in order to generate the second program, once their places are adapted. The places modification may comprise a permutation when the places are changed, or a push aside when an operation becomes parallel to another one, or to another branch of operations.

At least one of step parsing, step analysing and step changing is executed after step providing 100.

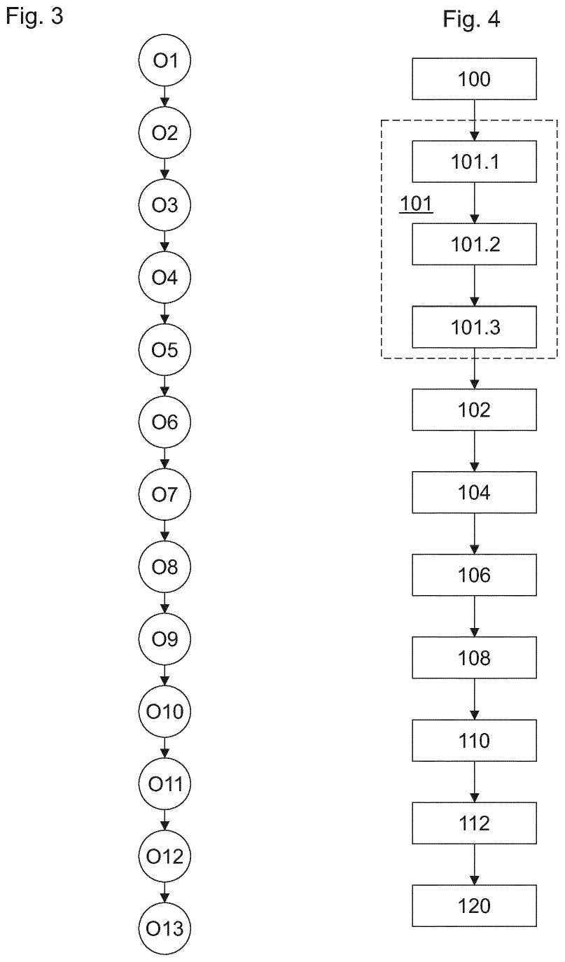

FIG. 3 provides a schematic illustration of another computer program. This computer program may correspond to a first program in accordance with the invention. The computer program is used for data preprocessing; notably in the context of machine learning.

The current computer program comprises more than three operations, for instance thirteen operations (O1-O13). However, this computer program may comprise more operations. The current first program may imply at least one database, for instance at least two databases on which data is stored.

In the current example, the first program comprises the following script:

O1. LOAD_FROM_FILE (‘dataset1’, ‘some_directory/
first_dataset.csv’, csv) // firstname, nationality
O2. LOAD_FROM_SQL_DB (‘dataset2’, query, credentials) //
firstname, nationality name, nbOfItems, totalPurchased
O3. FILTER (FIELD ‘dataset2.firstname’ != null) // remove null field
O4. REPLACE (‘dataset1.firstname’, trim (FIELD ‘dataset1.firstname’)) //
remove whitespace before and after firstname
O5. REPLACE (‘dataset1.firstname’, trim (FIELD ‘dataset1.nationality’)) //
remove whitespace before and after nationality
O6. REPLACE (‘dataset2.firstname’, trim (FIELD ‘dataset2.firstname’)) //
remove whitespace before and after firstname
O7. FILTER (FIELD ‘dataset2.firstname’ == “”) // remove empty firstname
O8. FILTER (FIELD ‘dataset1.nationality’ != “”) // remove empty nationality
O9. FILTER (FIELD ‘dataset2.nbOfItems’ > 0) // remove invalid number of items
O10. ADD (‘dataset2.meanPurchase’, FIELD ‘dataset2.totalPurchased’ / FIELD
‘dataset2.nbOfItems’) // compute mean price for an item
11. FILTER (FIELD ‘dataset2.totalPurchased’ > 0) // remove invalid totalPurchased
12. JOIN (‘dataset’, ‘dataset1’, ‘dataset2’, ‘firstname’, ‘firstname’,
[‘dataset1.nationality’, ‘dataset2.meanPurchase’]) // join two datasets
O13. PREPARE (‘dataset’, OPTIMISED, target, heuristics) //
or PREPARE(dataset, RAW) to run the script as-is.

As an alternative, the thirteenth operation O13 may be: PREPARE (dataset, RAW) to run the script as-is.

The current script may correspond to a pseudo code, for instance a pseudo source code. It may correspond to a mock programming language representing a typical program processed by the invention. Its factious operations illustrate the instructions involved. Different real programming languages may be used. Interpreted and compiled languages are considered.

The current script encloses comments introduces by the symbol: “//” as it is widespread in computer programming. These comments intend to explain the action entailed by the corresponding operations (O1-O13).

Each operation may correspond to a line of this source code. In the current first program, the operations (O1-O13) form a first sequence. The order of the first sequence may be deduced from the arrows between the operations (O1-O13). The current order according to which the operations (O1-O13) are listed corresponds to a sequence defined by a programmer. As an alternative, this sequence may have been automatically generated by another computer program.

The operations comprise at least one of the following; a data transformation operation, a loading instruction, a data creation function, which reuse pieces of data of the at least one data source.

It may be noticed that the first operation O1 and the second operation O2 both load data, but from different sources. Operations O3 to O13 comprise manipulations on the loaded data. These operations O3 to O13 may comprise mathematical operations such as additions, multiplications, divisions. They may comprise polynomials, derivates, matrix, complex numbers. The operations O3 to O13 may be carried out by primitives. Primitives my be understood as the simplest element available in a programming language.

The data comprises a first data set, also designated as first data collection, the at least one data source is a first data source read during the operation O1. A second data source, read at operation O2, provides a second data set. At least one of the operations, such as the twelfth operation O12 is a joining operation merging the first data set and the second data set. The first data source and the second data source may be physically installed at different locations, and may correspond to data of physical records at different areas, at different times.

Afterward, the method may execute other operations (not represented) corresponding to machine learning computation. As an alternative or an option, the method may carry out other functions as available in the field of big data.

It may be noticed that the current first program comprises several filtering operations (O7-O9). These operations intend to remove a data record where a dimension is invalid or incomplete. The current computer program may remove outliers, for instance data records too far from the others.

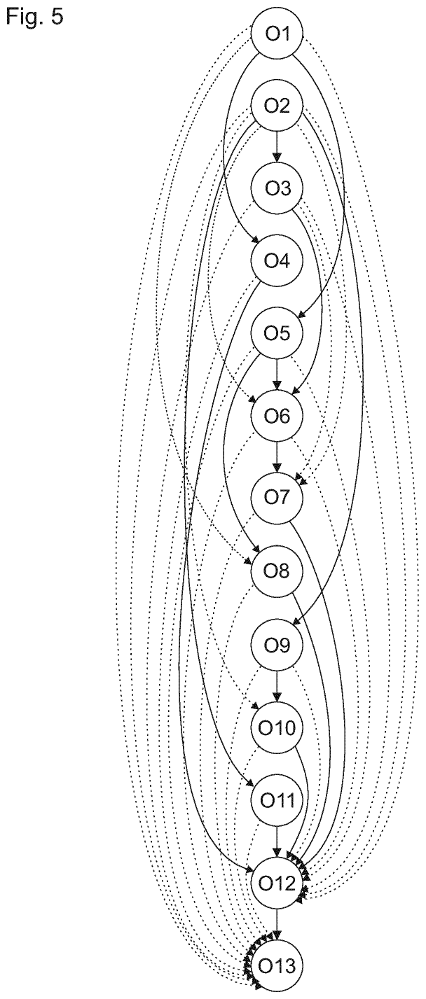

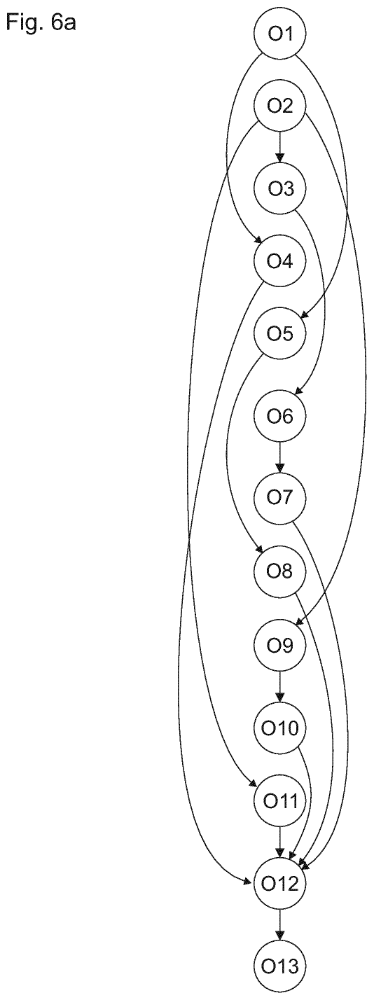

FIG. 4 provides a diagram block representing a computer implemented data processing method in accordance with the invention. The current computer implemented data processing method may be similar to the one as described in relation with FIG. 2.

The computer implemented data processing method comprises the following steps:
providing 100 a first program comprising an array, or group, or succession, of operations arranged to satisfy a first set of operation dependencies, said group of operations being adapted for computing data from at least one data source, preferably from at least two data sources;
parsing 101.1 the first program in order to detect operation dependencies, optionally of the first set;
analysing 101.2 the connections between the operation dependencies, optionally of the first set;
changing 101.3 the arrangement of the group of operations in order to meet a second set of operation dependencies, said second set comprising the first dependency (D1), the third dependency (D3); but not the second dependency (D2) which is set aside or abandoned; the second set comprises at least one, or several operation dependencies of the first set;
generating 102 a second program comprising said group of operations, arranged to satisfy the second set of operation dependencies;
computing 104 a first directed acyclic graph corresponding to the first program;
displaying 106, using a displaying unit, a second directed acyclic graph corresponding to the second program; without the second dependency;
   associating 108 priority levels to the operation dependencies;
   sending 110 instruction(s) to at least one database storing the data, the instruction being an instruction to run the second program and being coded in a language of the at least one data source,
combining 112 at least one operation dependency of the first set with at least one operation dependency of the second set in order to form a combined dependency; and
processing 120 the data from the at least one data source with the second program.

At step providing 100, the first program may correspond to the program as described in relation with FIG. 3.

At step obtaining 100, the first program is provided in a first programming/coding language, and at step generating 102 the second program is generated in a second programming/coding language, which is different from the first one. The first language may be an interpreted language, and the second language may be a compiled language, or vice-versa. The computer implemented data processing method may use one or more production systems, such as “Drools”, “Jess” or “Prolog”.

As a further alternative, at step providing 100 the first program, at least one of the operation dependencies is predefined, or provided.

At step parsing 101.1, the operations of the first program are read and compared in order to identify which operations are interdependent, and which one need to be executed before/after the others. For instance, the method analyses the operations requesting a reading or a writing action.

For this purpose, step parsing 101.1 may execute the following pseudo-code in order to detect writing actions:

```
function writtenFields(ops : Array [Operation}) : Array[List[Field]] = {
  res = Array[length(ops)]
  for (i = 0; i < length(ops); i++) {
    switch ops[i] of
      REPlACE(field, action) => res[i] = List(Field(field))
      ADD(field, action) => res[i] = List(Field(field))
      FILTER(action) => res[i] = [] // this action reads fields but do not write
      ...
      default => res[i] = null // for unknown operations - these
operations are considered as reading and writing everything
  }
  return res
}
```

With respect to the reading action, step parsing 101.1 may execute the following pseudo-code:

```
function readField(ops : Array [Operation}) : Array[List[Field])] = {
  res = Array[length(ops)]
  for (i = 0; i < length(ops); i++) {
    switch ops[i] of
      REPlACE(field, action) => res[i] = res[i] == list_field(action)
      ADD(field, action) => res[i] = res[i] == list_field(action)
      FILTER(action) => res[i] = res[i] == list_field(action)
      ...
      default => res[i] = null // for unknown operations - these
operations are considered as reading and writing everything
  }
  return res
}
```

As an option, the function are analysed at the expression level. In this context, step parsing 101.1 may execute the following pseudo-code:

```
function list_fields(action : Expression) : List(Field) = {
  switch action of
    trim(x) => return list_fields(x)
    x != y => return list_fields(x) ++ list_fields(y)
    ...
    FIELD x => return List(x)
    default => return null // for unknown actions - these
actions are considered as touching every fields
}
```

Afterward, step parsing 101.1 may provide a matrix of dependencies. The matrix may include a Boolean matrix defining if an option needs to be executed before another one. This may be obtained by the following pseudo-code:

```
function rw_precedence(ops: Array[Operation]) : Array[Array[Boolean]] = {
  line = Array.fill(length(ops), False)
  res = Array.fill(length(ops), line)
  read = readField(ops)
  write = writeField(ops)
  for (i = 0; i < ops.length; i++) {
    for (j = i+1; j < ops.length; j++) {
      if ( write [i] == null
          || read[j] == null
          || any(read[j], x => write[i].contains(x))) //
there is a precedence between i and j if i write a data that j is supposed to read
      then res[i][j] = True
      else res[i][j] = False
    }
  }
  // the transitive closure of the precedence
  for (i = 0; i < ops.length; i++) {
    for (j = i+1; j < ops.length; j++) {
      if(res[i][j]) {
        for (k = j+1; k < ops.length; k++) {
          if (res[j][k]) then res[i][k] = True
        }
      }
    }
  }
  return res
}
```

At step changing 101.3, the method may adapt the respective positions of the operations. The precedence, or transfer into a parallel branch, of an operation may be executed.

In order to change the priority of operations, for instance in light of the dataset size reduction, the method may execute the following pseudo code:

```
function reduceSize(op: Operation) : Bool = {
    switch op of
      REPlACE(field, action) => return False
      ADD(field, action) => return False
      FILTER(action) => return True
      ...
      default => return False
  }
}
```

function pushupReducers(ops: Array[Operation], precedence: Array[Array[Boolean]]):

```
Array[Operation] {
  copy_ops = copy(ops)
  copy_precedence = copy(precedence)
  for (i = 0; i < length(copy_ops); i++) { //for each operation i
    if (reduceSize(copy_ops[i])) // if it already reduces the length
    then for (j = i−1; j >= 0; j−−) { // then for each preceding operation j
      if (!reduceSize(copy_ops[j]) && !copy_precedence[j][i]) //
if j does not reduce the size of the dataset and j has not to precede i
      then {
        permuteOperations(i, j, copy_ops) // permtute
        permutePrecedence(i, j, copy_precedence) // permtute
      }
    }
  }
  return copy_precedence
}
```

Step parsing 101.1 is not an essential step of the invention. It may be replaced by a step obtaining the operation dependencies.

The method may comprise a step copying or a step transferring or a step loading the group of operations of the first program. Step copying or step transferring may be enclosed in step generating 102. As an alternative, it may be in step changing 101.3.

At step analysing 101.2 the connections, the connections may comprise a same operation. It may be a same starting operation or a same end operation, for instance when defining parallel branche(s).

The connections may be logical connections. The connections may be links. The or at least one connection(s) may comprise interdependence feature(s).

The process may generally comprise a step adapting operation dependencies which gathers, and notably replaces steps: parsing 101.1, analysing 101.2, and changing 101.3.

Step generating 102 may comprise the transmission of the output of step changing 101.3 to a compiler or to an interpreter.

At step computing 104 a first directed acyclic graph, the latter may be displayed by means of a displaying unit, such as a graphical user interface. Said displaying unit may be the one which is used at step displaying 106 the second directed acyclic graph.

The first directed acyclic graph may correspond to the representation provided in FIG. 3. The operations (O1-O13) form a single branch, or a single thread. This first directed acyclic graph presents a single starting operation O1, and a single end operation O13. Except these two operations O1 and O13, each other operation (Oi, where the indicia “i” is an integer ranging from 2 to 12) comprises an ancestor operation (Oi−1), and a descendent operation (Oi+1) also designated as successor operation.

The operations (O1-O13) are joined by edges, for instance by arrows with a peak oriented toward the execution direction of the first directed acyclic graph. The operations (O1-O13) are arranged in accordance with their indicia.

Back to FIG. 4, at step displaying 106 the second directed acyclic graph, said second graph comprises nodes corresponding to the operations of the group of operations, and further comprises edges joining the nodes. The same may apply to the first directed acyclic graph as defined in relation with step computing 104.

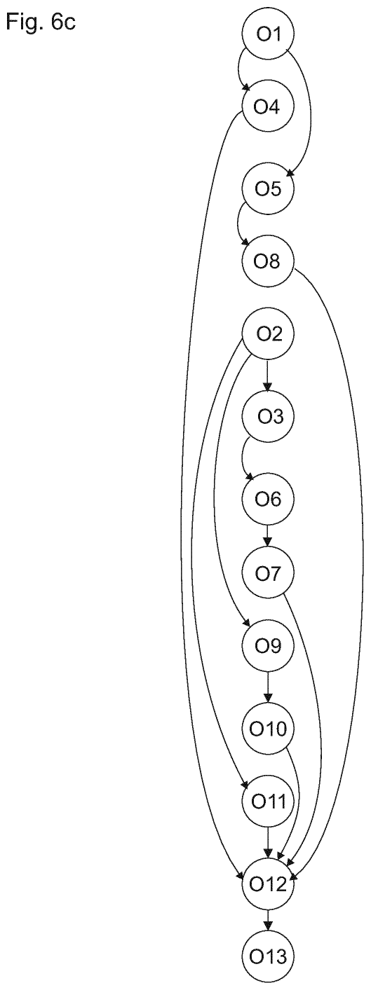

Representations of the second directed acyclic graph are provided in FIGS. 6a, 6b, 6c, 7a, 7b, 8 and 9. By comparison of the FIGS. 6a, 6b, 6c, 7a, 7b, 8 and 9) with FIG. 3, it may be noticed that the second program comprises the same number of operations than the first program. As a further general remark, the operations (O1-O13) are all kept. There is operation preservation. Only the operation arrangement changes. The edges, notably the arrows, are changed. The positions of the operations are reorganised.

The operations (O1-O13) are represented by means of circles; also designated as nodes; and dependencies are represented by means of edges (not labelled for the sake of clarity of the figure). The dependencies are currently precedence dependencies. Thus, the edges may be arrows (not labelled) pointing downward, or more generally in the growing direction of the indicia of the operations (O1-O13). As an alternative, the dependencies could impose to execute the operation Oi after the operation Oi+1. For instance, these dependencies impose to execute the first operation O1 before the fourth operation O4, the second operation O2 before the third operation O3, and the twelfth O12 operation before the thirtieth operation O13.

At step providing 100 the first program, the operation dependencies may be obtained by parsing the operations of the first program and/or by analysing part of the data involved in these operations (O1-O13).

The dependencies between the operations may be precedence rules listed in the following table. Thus, the following dependencies may be defined in relation with the first computer program as proposed in relation with FIG. 3 (for the sake of conciseness, the i-eth operation is merely referred to as Oi; where “i” is an indicium varying from 1 to 13):

O1 before: O4, O5, O8, O12, and O13;
O2 before: O3, O6, O7, O9, O10, O11, O12, and O13;
O3 before: O6, O7, O12, and O13;
O4 before: O12, and O13;
O5 before: O8, O12, and O13;
O6 before: O7, O12, and O13;
O7 before: O12, and O13;
O8 before: O12, and O13;
O9 before: O10, O12, and O13;
O10 before: O12, and O13;
O11 before: O12, and O13;
O12 before: O13.

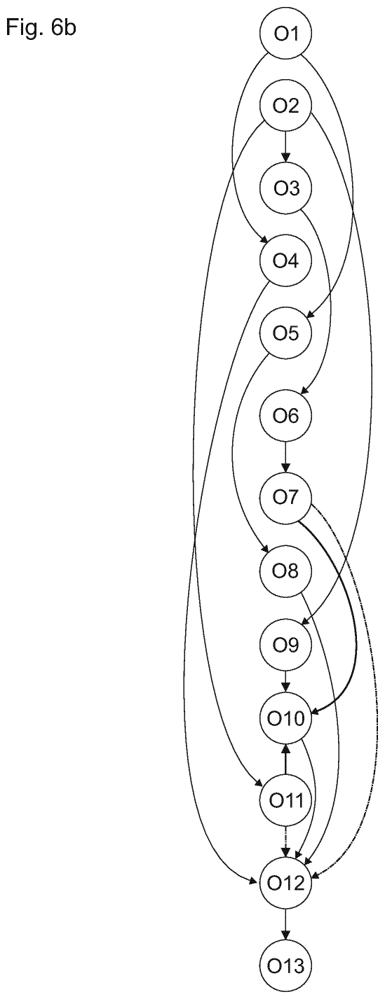

The result of the dependencies between the operations O1 to O13 is represented in FIG. 5. The preceding operations, with exception of the thirteenth operation O13, are provided with lists of dependencies. All the operations are dependent upon at least one other operation or several other operations. Thence, the operations are all interconnected by the first set of dependencies.

It appears that the thirteenth operation O13 is dependent upon all other operations (O1-O12). The twelfth operation O12 is dependent upon all preceding operations (O1-O11). It may be underlined that the combination of the first operation O1 and the second operation O2 constrains all the following operations (O3-O13). The combination of the starting operations defines the operation dependencies of all other operations. The end operation, or the combination of the end operations, is dependent upon all other operations, notably the upstream operations.

As an alternative, the dependencies could be defined as successions. Thus, a dependency table may comprise the following dependencies:

O3 after O2;
O4 after O1;
O5 after: O5;
O6 after: O3 and O2;
O7 after: O6, O3 and O2;
O8 after: O8 and O1;
O9 after O2;
O10 after O2;
O12 after: O1, O2, O3, O4, O5, O6, O7, O8, O9, O10, and O11;
O13 after: O1, O2, O3, O4, O5, O6, O7, O8, O9, O10, O11, and O12.

The precedence dependencies are interesting as they provide a dependency starting from more operations. Thus, generating the second program becomes easier. The precedence rules guide the transformations, and are preserved through the transformations. Consequently, the precedence rules ensure that the output of the second program is equal to the output of the first one.

At step combining 112 at least one operation dependency is combined with at least one other operation dependency from the same first set. If another operation dependency of the first set corresponds to the result of said combined dependencies, then at step generating 102 the second set of operation dependencies is defined without said another operation dependency.

For instance, at step combining 112, the operation dependency between the twelfth operation O12 and the thirteenth operation O13 is combined with the operation dependency between the eleventh operation O11 and the twelfth operation O12. In FIG. 5, these operation dependencies are represented in solid lines. It is noteworthy that this combination is equivalent to the operation dependency (represented in doted lines in FIG. 5) between the eleventh operation O11 and the thirteenth operation O13. The resulting combination provides the same path. Then at step generating 102, the second set of operation dependencies is defined without the operation dependency between the eleventh operation O11 and the thirteenth operation O13.

The current principle is detailed in relation with the eleventh, twelfth and thirteenth operations (O11-O13). However, it may be generalized to the first set in its entirety.

The operation dependency between the eleventh operation O11 and the twelfth operation O12 is an elementary dependency. The operation dependency between the twelfth operation O12 and the thirteenth operation O13 is also an elementary dependency. By contrast, the operation dependency between the eleventh operation O11 and the thirteenth operation O13 is a bypass dependency bypassing the twelfth operation O12 whereas it is associated with the two previous elementary dependencies. At step generating 102 the operation dependencies between the operations of the second set are defined without the bypass dependency/dependencies. In the current context, a dependency “between” operations means constraining directly these operations. There is not intermediate operation in the dependency definition. Graphically, the edge directly touches both operations.

Before step generating 102, each operation dependency of the lists of operation dependencies of the operations are applied to the other lists of operation dependencies of the first set such that several operation dependencies form overlapping dependencies which overlaps other dependencies. At step generating 102 the operation dependencies between the operations of the second set are defined without the overlapping dependency/dependencies.

By way of illustration, we refer to the last three operations. The operation dependency between the twelfth operation O12 and the thirteenth operation O13 is applied to the operation dependency between the eleventh operation O11 and the twelfth operation O12. The result matches the operation dependency between the eleventh operation O11 and the thirteenth operation O13; which is hereby considered as an overlapping operation dependency. At step generating 102 the operation dependencies of the second set are defined without the later operation dependency.

Before step generating 102, the operation dependencies of the lists are integrated in the other lists of the first set rendering redundant some of the operation dependencies. At step generating 102 the operation dependencies between the operations of the second set is defined without the redundant dependency/dependencies.

For explanatory purposes, the operation dependency between the eleventh operation O11 and the twelfth operation O12 is integrated to the operation dependency between the twelfth operation O12 and the thirteenth operation O13. This integration renders redundant the operation dependency between the eleventh operation O11 and the thirteenth operation O13 which is not used in the second set of operation dependencies at step generating 102.

In other words, if we inject the rule {O12 before O13} applying to the operation O12 to the rule above {O11 before O12 and O13} (or we replace O12 to the rule applying thereon), we obtain: O11 before {[O12 before O13] and O13}

It may be developed mathematically as follows:

O11 before O12 before O13, and O11 before O13

The order between O11 and O13 is defined twice. Thus, a simplification is allowable. We obtain: O11 before [O12.=>O11 before O12;

We can operate in the same way on the whole table. Each time, the operations are replaced by their corresponding rules, and redundant order constraints are deleted.

At the end, in each line the table only keeps operations which are elementary ones, namely not composed of other ones.

The first program is run on a first computer. At step processing 120 the second program is run on a data server, for instance a distributed data server. The data server may be distributed on several interconnected computers, for instance on a second computer, a third computer, and a fourth computer. Further computers may be provided if required.

During step associating 108, priority levels are associated to the operation dependencies. Similarly, priority levels may be associated to the operations. At step generating 102 the orders between the operations is defined in relation with the priority levels of the operations and/or of the dependencies. Step associating 108 is purely optional in view of the current invention.

As an alternative, it may replace the parsing phase that is operated during step providing 100. The method may further comprise a step obtaining a target architecture to which the second program will conform. The architecture may be obtained by rules defined by computing means depending on technical requirements.

Generally, the computer implemented data processing method is an iterative method. A program resulting from the step generating 102 the second program is stored in a memory element after a first iteration, the subsequent program resulting from a subsequent iteration is stored in another or the same memory element. Afterward, the subsequent program is compared to the program resulting from the first iteration. Thus, computation is reduced since previous computation may be reused. In the context of machine learning, this aspect is of high importance as early computations may require long computation runtimes.

At least one or each feature defined in relation with step generating 102 may apply to each of: step parsing 101.1; analysing 101.2 and changing 101.3.

FIG. 5 provides a schematic illustration of the operations O1 to O13. Edges, notably arrows, represent the operation dependencies (unlabelled). The operation dependencies correspond to those that are defined in FIG. 4.

The operation dependencies each comprise a direction. Each operation dependency is defined in relation with an ancestor and a successor. In FIG. 5, the operations (O1-O13) are listed as in the sequence represented in FIG. 3. The operations (O1-O13) are represented in the same order.

FIG. 5 illustrates all the dependencies obtained from their automatic definition by means of a parsing phase of the pseudo source code as detailed in relation with FIG. 3. Here, more operation dependencies are represented than in FIG. 3.

The first set of operation dependencies as represented in FIG. 5 comprises more operation dependencies than the second set as represented in FIGS. 6a, 6b, 6c, 7a, 7b, 8 and 9. The first set may be an exhaustive listing that is obtained by means of theorical rules.

By convention operation dependencies, possibly all operation dependencies, that correspond to combinations of other operations dependencies are represented with doted lines in current FIG. 5. The elementary operation dependencies are represented with solid lines. An elementary operation dependency may be understood as an operation dependency connecting two subsequent operations.

An elementary operation may also mean an operation dependency connecting two operations that are not connected by other elementary operations, notably after parallelization. Accordingly, an elementary operation may bypass another operation in an intermediate representation of the first program.

FIG. 6a provides a schematic illustration of the second directed acyclic graph corresponding to the second program in accordance with the invention. It may correspond to the second directed acyclic graph as defined in relation with step displaying 106 the second directed acyclic graph of FIG. 4.

By contrast over FIG. 5, in current FIG. 6a the dependencies represented with doted lines are deleted. Thus, elementary operation dependencies are kept, and the composed operation dependencies are removed from the second set.

By comparison with FIG. 5, all the operations dependent upon at least one operation dependency of the second set are dependent upon at least one operation dependency of the first set. Thus, several operation dependencies of the second set correspond to some operation dependencies represented in FIG. 5, or even in FIG. 3. Yet, in FIG. 6a there is less operation dependencies than in FIG. 5. There may be more operation dependencies than in FIG. 3 since parallelization generates another starting operation from which operation dependencies are defined.

Thus, the invention not only reduces the number of dependencies, it also fosters the automatic definitions of different starting operations O1 and O2. The invention offers a compromise between the constraint's definition and the available information on operations in order to speed up processing. It becomes easier to simultaneously define parallel branches and to optimise the operation orders.

The first program and the second program are arranged such that they provide the same output when they are fed with the same input. Indeed, they comprise the same number of operations. All the operations of the second program are the operations of the first program. Accordingly, the first program provides a first data result when it computes an input data, and the second program is arranged in order to provide a second result data when it computes said input data. It is noteworthy to underline that the second result data corresponds; preferably is identical or similar or equivalent; to the first result data. In other words, the first program and the second program are configured for providing a same output data, or an equivalent output data, or a corresponding output data, when they are provided with a same input data. The end operations O13 are the same, which contributes to providing the same result. One of the differences between these programs lies in their operation dependencies. They have the same operations, but constrained in another manner, for instance a manner allowing parallelization and/or allowing another order arrangement.

FIG. 6b provides a schematic illustration of the second directed acyclic graph corresponding to the second program as presented in the previous figures. The second directed acyclic graph exhibits a second set of operation dependencies represented by edges in solid lines. The edges may be arrows, thus with a direction corresponding to an order to execute the operations (O1-O13). In the current illustration at least, the order corresponds to a precedence.

The data processing method in accordance with the invention is optionally configured for executing the filtering operations O7, O9 and O11 before an operation manipulating their data, such as the tenth operation O10 which is connected to the same starting point O2. For this purpose, new operation dependencies are added and defined with respect to the tenth operation O10. One is staring from the seventh operation O7, and another one comes from the eleventh operation O11. By the way, the latter operation dependency is oriented in the contrary direction than the other. This graphical difference may imply another action that will be descried later on. The tenth operation O10 becomes a hub operation, toward which the branches converge.

It may be underlined that the filtering operations O7, O9 and O11 reduce the size of the data from at least one data source, said data notably being an input data. These operations may allow a size reduction of an input file. Thus, the positions of these operations become closer to the starting operation, for instance operation O2. Their positions may be permuted with other operations. They may be shifted upward. As an option, they may be integrated in a new operation branch, for instance a parallel operation branch. The process may comprise the creation of a new branch, or parallel branch(es).

In order to avoid superfluous, or redundant operation dependencies, the previous one (represented with a mix line) between the seventh operation O7 and the twelfth operation O12 is removed from the second set of operation dependencies. The former operation dependency between the eleventh operation O11 and the twelfth operation O12 is also deleted.

FIG. 6c provides a schematic illustration of the second directed acyclic graph corresponding to the second program in accordance with the invention. It may be similar to the second directed acyclic graph as represented in FIG. 6a, however it differs in that the operations (O1-O13) are arranged according to another order, for instance not in accordance with their indicia.

Similarly with FIGS. 3 and 5, the thirteenth operation O13 is still the end operation; also designated as “final operation”. The first operation O1 is still at the beginning of the current operation sequence.

In the first program where the operations are constrained by the first set, these operations (O1-O13) are listed in accordance with a first sequence. In the second sequence of the second program the execution order between the fourth operation O4 and the second operation O2 is inverted with respect to the first sequence. The fourth operation O4 may be before the second operation O2 and the third operation O3. The eighth operation O8 becomes closer to the associated starting operation O1. The current sequence does not only sort the operations (O4, O8) on the basis of their indicia. As a graphical consequence, the dependencies do not cross each other.

This translates the fact that it is easier to parallelize the second computer program. Different assemblies of operations emerge. The conflict between the operation dependencies are avoided, or easier to manage.

The invention also contemplates a combination of the second programs in accordance with FIGS. 6b and 6c.

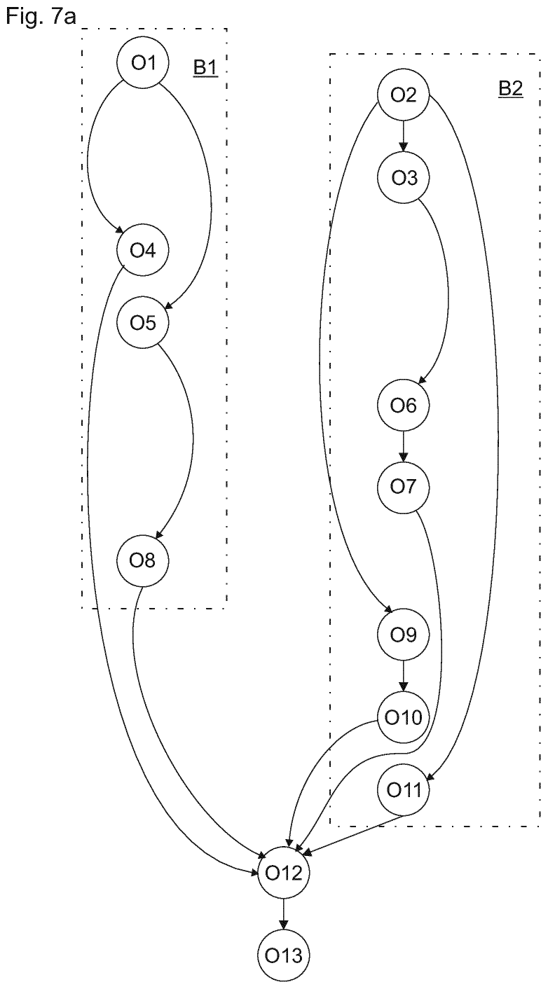

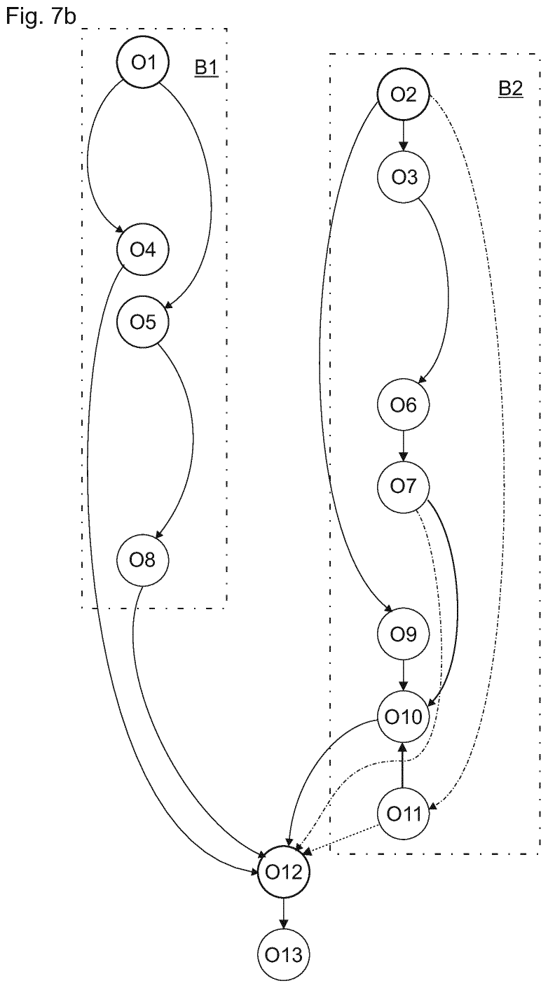

FIG. 7a provides a schematic illustration of the second directed acyclic graph corresponding to the second program in accordance with the invention. It may be similar to the graph as described in relation with FIG. 6c.

There, two parallel clusters are spaced from each other. Each cluster is dependent upon the twelfth operation O12. Each branch comprises a succession of operations connected to the twelfth operation O12.

The first branch B1 on the left side comprises the operations O1, O4, O5 and O8. The second branch B2 comprises the operations; O2, O3, O6, O7, O9, O10 and O11. Both branches are independent from each other, and may be executed in isolation from the other. One branch may be executed on one computer or server, and the other one may be executed on another computer and/or another server. Each time, the second program may comprise instructions in different languages corresponding to the computer or server. Each branch may be associated with one of the data sources, said data source comprising the same kind of data.

Similarly with FIG. 3, the twelfth operation O12 and the thirteenth operation O13 form the last two and ultimate operations. By contrast with the previous figures, there is currently two beginning operations: the first operation O1 and the second operation O2. Each of them forms a starting point, each starting point may be associated with one of the databases storing data.

FIG. 7b provides a schematic illustration of the second directed acyclic graph corresponding to the second program in accordance with the invention. It may be similar to the graph as described in relation with FIG. 7a, and comprises operation dependencies which are adapted in relation with FIG. 6b.

The dependencies are adapted in the second branch B2. The first branch B1 remains the same. In the current embodiment, only two branches are represented. However, the invention is also adapted for sequence configurations where there are at least three branches.

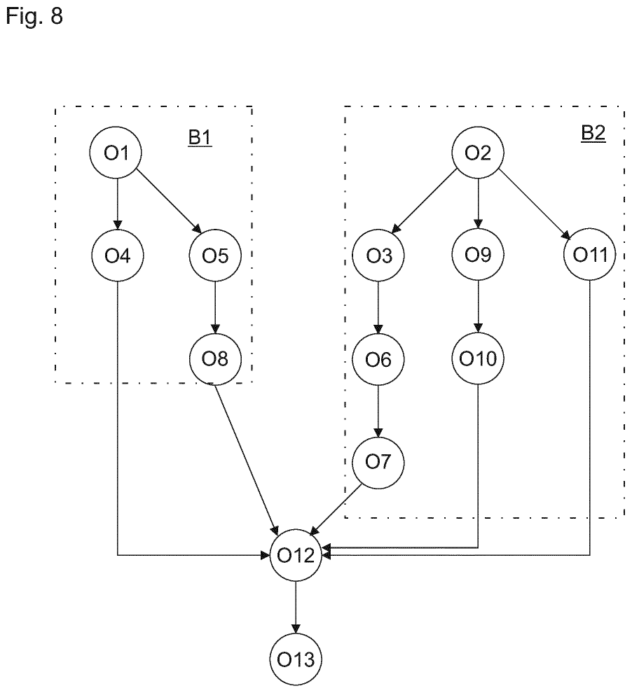

FIG. 8 provides a schematic illustration of the second directed acyclic graph corresponding to the second program in accordance with the invention. The current second directed acyclic graph may be similar to the ones as described in relation with FIGS. 6c and 7a.

In each branch, the operations (O1-O13) are further parallelized. The first branch B1 comprises a sub-branch with operation O4, and another sub-branch with operations O5 and O8. The second branch B2 comprises, in the current example, three sub-branches. The sub-branches are parallel. The first one is formed by the operations O3, O6 and O7, the second one is formed with the operations O9 and O10, and the third one comprises the eleventh operation O11. Thus, the current second program may be decayed, expanded, in five sub-branches. The operations O4, O5, O3, O9 and O11 may be executed in the meantime, in parallel, independently from each other in different computing systems. Since each sub-branch may be executed on a different computer, the computation is shared on multiple processors such that time is saved for processing, or preprocessing, data. The processors may be multicore, each multicore processor being associated with one branch or sub-branch.

The branches B1 and B2 may be executed independently from each other. It may be considered that the eighth operation O8 is executed simultaneously with the operations O6 and O10. However, it is also possible to shift the execution order of operation O8, and to execute it simultaneously with the seventh operation O7. Other shifts are considered, notably in order to share available resources, and to improve resource balance.

According to another approach, the branches (B1, B2) and their sub-branches may be considered as bundles and ramifications respectively.

In the first program, the operations of the group of operations are listed in accordance with the first sequence. In the second program the positions between the seventh operation O7 and the eighth operation O8 is inverted with respect to the first sequence. The eighth operation O8 is sorted before the seventh operation O7. In the current program, the eighth operation O8 is dependency free with the seventh operation O7. However, the seventh operation O7 and the eighth operation O8 share a common successor O12. They may be executed in parallel, before the twelfth operation O12. The operations of the first branch B1 may be dependency free with the operations of the second branch B2. Thus, these operations may be carried out in a further additional sequence. Several possibilities are offered for executing the second program, there is more freedom for sharing the computing instructions.

At step processing the fourth operation O4 and the fifth operation O5 are run in parallel. Similarly, the third operation O3, the ninth operation O9 and the eleventh operation O11 are run in parallel. Furthermore, the sixth operation O6 and the tenth operation O10 may be run in parallel. Thus, parallelization may occur at different computations phases. At least one computation phase may parallelize at least three operations.

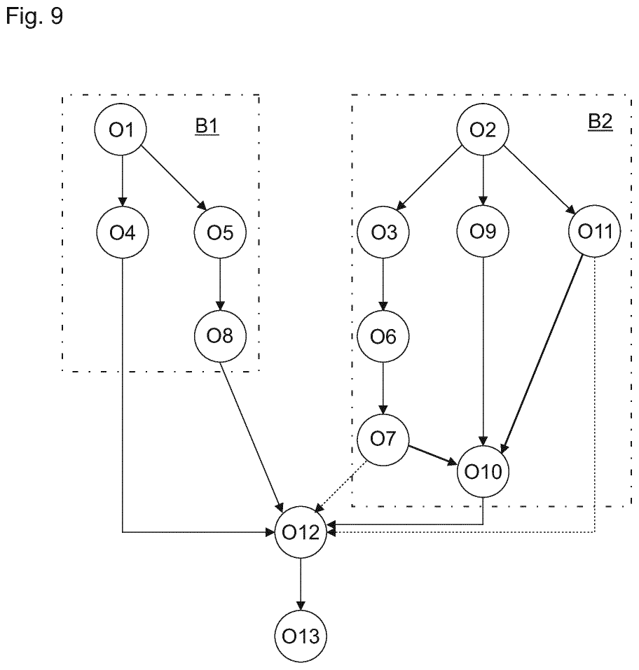

FIG. 9 provides a schematic illustration of the second directed acyclic graph corresponding to the second program in accordance with the invention. The current graph is similar to the graph as presented in relation with FIG. 8 with regard to the parallelization aspect. The dependencies are similar to the teachings of FIGS. 6b and 7b.

Since the execution of the tenth operation O10 is defined after the operations O7, O9 and O11 of the same branch B2, another computation phase is added in the sequence. The sequence of the second branch B2 is longer than in the previous figure since it comprises an additional computation layer or computation phase.

At least one operation of the first program is a filtering operation, and comprises an execution order which is brought forward in the second program, as compared to the first program, and/or with respect to another operation. The seventh operation O7 has an operation order which is before the tenth operation O10. Thus, the second set of dependencies is adapted such that the execution order of the seventh operation O7, ninth operation O9 and eleventh operation O11 is forced to be before the tenth operation O10. Their priority level changes.

In the first program, the operations of the group of operations are listed in accordance with the first sequence, and in the second sequence in the second program. The second program allows that the seventh operation O7 becomes before the tenth operation O10. Their positions in the sequences are inverted. The seventh operation O7 starts and ends before the tenth operation O10 is executed, or initiated.

When several branches emerge, the invention suppresses dependencies within different branches by comparison with FIGS. 3 and 5. Automatically, several operations are defined as being executed simultaneously. The invention may provide that one operation receives a dependency with respect to an operation from another branch. It may be defined that one operation from a sub-branch is executed at the end of the corresponding branch, and possibly after all other operations of the associated branch.

The invention has been described in relation with a machine learning process. However, it could be applied to a deep learning process as well. It may be used with an un-supervised and unlabelled learning data. The machine learning algorithm may be specialized to a classification method, a prediction algorithm, a forecast method.

The invention may be implemented with Python, and with R. Other languages remain possible. The invention may be considered as language agnostic. The distributed computation, for balancing operations, may use the environment Scala. The libraries Spark, Akka, and Hadoop may be used.

It should be understood that the detailed description of specific preferred embodiments is given by way of illustration only, since various changes and modifications within the scope of the invention will be apparent to the person skilled in the art. The scope of protection is defined by the following set of claims.

1. A computer-implemented data processing method comprising:
providing, via processor, a first program comprising a group of operations arranged to satisfy a first set of operation dependencies, said group of operations being adapted for computing data from at least one data source in order to provide a first data result;
the group of operations comprises:
a first operation,
a second operation, and
a third operation;
the first set of operation dependencies comprises:
a first dependency between the first operation and the second operation,
a second dependency between the first operation and the third operation, and
a third dependency between the second operation and the third operation;
the method further comprising:
parsing, via the processor, the first program in order to identify the operation dependencies;
analysing, via the processor, one or more connections between the operation dependencies;
changing, via the processor, an arrangement of the operations of the group of operations in order to satisfy a second set of operation dependencies which is defined:
with the first dependency, the third dependency; and
without the second dependency;
generating, via the processor, a second program comprising said group of operations, arranged to satisfy the second set of operation dependencies;
processing, via the processor, the data from the at least one data source with the second program in order to provide a second data result, said second data result corresponding to the first data result.

2. The computer-implemented data processing method of claim 1, wherein the operation dependencies of the first set and of the second set are precedence dependencies, notably imposing to perform the first operation before the second operation.

3. The computer-implemented data processing method of claim 1, wherein the first set comprises more operation dependencies than the second set.

4. The computer-implemented data processing method of claim 1, wherein the group of operations further comprises a fourth operation, the first set further comprising a fourth dependency between the first operation and the fourth operation, the second operation being dependency free with respect to the fourth operation.

5. The computer-implemented data processing method of claim 4, wherein at step generating, the dependency between the second operation and the fourth operation is such that they are executed in parallel, and at step generating the second set of operation dependencies is defined with the fourth dependency, the fourth dependency being configured such that at step processing the fourth operation is executed before the third operation and before the second operation.

6. The computer-implemented data processing method of claim 1, wherein all the operations dependent upon at least one operation dependency of the second set are also dependent upon at least one operation dependency of the first set.

7. The computer-implemented data processing method of claim 1, wherein at least one operation of the group of operations is a data transformation operation.

8. The computer-implemented data processing method of claim 1, wherein at least one operation of the group of operations is a loading instruction.

9. The computer-implemented data processing method of claim 1, wherein at least one operation of the group of operations is a data creation function, which reuse pieces of data of the at least one data source, and comprises an order priority which is modified, notably lowered, in the second program, as compared to the first program.

10. The computer-implemented data processing method of claim 1, wherein at least one operation of the group of operations is a filtering operation, and comprises an execution order which is brought forward in the second program, as compared to the first program.

11. The computer-implemented data processing method of claim 1, wherein said data comprises a first data set, the at least one data source is a first data source and further comprises a second data source which provides a second data set, at least one of the operations is a joining operation merging the first data set and the second data set.

12. The computer-implemented data processing method of claim 1, wherein at least one operation of the first operation, second operation and third operation enables a size reduction of the data from at least one data source, said at least one operation being permuted in the second program with respect to the first program.

13. The computer-implemented data processing method of claim 1, wherein at step providing, at least one of the operation dependencies is predefined.

14. The computer-implemented data processing method of claim 1, wherein the operations in the first program and in the second program comprise a same end operation and/or a same starting operation.

15. The computer-implemented data processing method of claim 1, wherein in the first program, the operations of the group of operations are listed in accordance with a first sequence, and in the second program the execution order between the second operation and the third operation is inverted as compared to the first sequence.

16. The computer-implemented data processing method of claim 1, wherein the computer-implemented data processing method comprises a step computing a first directed acyclic graph corresponding to the first program.

17. The computer-implemented data processing method of claim 1, wherein the computer computer-implemented data processing method comprises a step displaying, using a display unit, a second directed acyclic graph corresponding to the second program; without the second dependency; each graph comprising nodes corresponding to the operations of the group of operations, and further comprising edges joining the nodes.

18. The computer-implemented data processing method of claim 1, wherein at step obtaining, the first program is provided in a first coding language, and at step generating the second program is provided in a second coding language, which is different from a first language.

19. The computer-implemented data processing method of claim 1, wherein the first program is run on a first computer, and/or the second program is run on a data server.

20. The computer-implemented data processing method of claim 1, wherein the method comprises a step associating priority levels to the operation dependencies and/or to the operations, at step generating the order between the operations being defined in relation with said priority levels.

21. The compute implemented data processing method of claim 1, wherein the computer-implemented data processing method is an iterative method, a program resulting from the generating said second program is stored in a memory element after a first iteration, a subsequent program resulting from a subsequent iteration is stored in a memory element and compared to the program resulting from the first iteration.

22. The computer-implemented data processing method of claim 1, wherein the computer-implemented data processing method comprises a step sending instruction(s) to a database storing the data, the instruction being an instruction to run the second program and being coded in a language of the at least one data source.

23. The computer-implemented data processing method of claim 1, wherein the computer-implemented data processing method is a supervised machine learning data pre-processing method, and the data is a learning data for the supervised machine learning data pre-processing method.

24. The computer-implemented data processing method of claim 1, wherein the computer-implemented data processing method further comprises a step combining at least one operation dependency of the first set with at least one other operation dependency of the first set in order to form a combined dependency, if another operation dependency of the first set corresponds to the combined dependency, then at step generating, the second set of operation dependencies is defined without said another operation dependency.

25. The computer-implemented data processing method of claim 1, wherein the first dependency is an elementary dependency and the second dependency is a bypass dependency bypassing the second operation with which the elementary dependency is associated, at step generating the operation dependencies of the second set are defined without the bypass dependency.

26. A computer program comprising instructions, which when the program is executed by a computer, cause the computer to carry out the computer-implemented data processing method of claim 1.

27. A computer program product including a computer readable medium on which the computer program of claim 26 is stored.

28. A computer configured for performing the computer-implemented data processing method of claim 1.
